(19) United States
(12) Patent Application Publication
(10) Pub. No.: US 2013/0166656 A1
(43) Pub. Date: Jun. 27, 2013

(54) SYSTEM AND METHOD FOR SHARING DIGITAL IMAGES

(71) Applicants: Hay Taub, Rosh Haayin (IL); Moshe Hason, Tel Aviv (IL)

(72) Inventors: Hay Taub, Rosh Haayin (IL); Moshe Hason, Tel Aviv (IL)

(73) Assignee: PUMPIC LTD., Rosh Ha'ayin (IL)

(21) Appl. No.: 13/337,332

(22) Filed: Dec. 27, 2011

(51) Int. Cl. G06F 15/16

(52) U.S. Cl. 709/206; 709/217

(57) ABSTRACT

A method, implementable on a computing device, for downloading original images includes downloading an image via a communications network; calculating a unique picture ID (UPID) for the downloaded image, where the UPID is a mathematical construct with a generally unique, resolution independent, relationship with the downloaded image; sending a download request with at least the calculated UPID to an image brokerage server, where the brokerage server is configured to store at least the UPIDs associated with the original resolution images stored on other devices; and receiving the original resolution image of the downloaded image from one of the other devices, where the UPID associated with the original resolution image matches the calculated UPID.

### FIELD OF THE INVENTION

The present invention relates to sharing digital images generally and to providing higher quality versions of the images in particular.

### BACKGROUND OF THE INVENTION

Social networks, such as, for example, Facebook, are among the most popular vehicles for the dissemination of digital images. Every day, thousands and even millions of digital images are posted to such networks and are typically visible to other members of the social network, particularly the “friends” or “buddies” of the posting user, although not always the general public. The images are often “tagged” to identify the people represented in the images. Typically, when the tagged images represent other members of the same social network, the tagged members are notified that they have been tagged in a new image and provided with a link to view the image.

Once posted on a social network, an image is generally available for forwarding and/or downloading by anyone that can “see” it. However, quite often, the posted versions of the digital images are not optimal. The resolution and/or size of the digital images are often reduced in order to reduce the file size of the image in order to conform with storage space restrictions, performance requirements and/or available transmission bandwidth. Accordingly, the quality of the disseminated image is often inferior to that of the original image.

### SUMMARY

There is provided, in accordance with a preferred embodiment of the present invention, a method, implementable on a computing device, for downloading original images including downloading an image via a communications network; calculating a unique picture ID (UPID) for the downloaded image, where the UPID is a mathematical construct with a generally unique, resolution independent, relationship with the downloaded image; sending a download request with at least the calculated UPID to an image brokerage server, where the brokerage server is configured to store at least the UPIDs associated with the original resolution images stored on other devices; and receiving the original resolution image of the downloaded image from one of the other devices, where the UPID associated with the original resolution image matches the calculated UPID.

Further, in accordance with a preferred embodiment of the present invention, the method also includes scanning websites for tagged images to download.

Still further, in accordance with a preferred embodiment of the present invention, the method also includes enabling a user to select the image for the downloading.

There is also provided, in accordance with a preferred embodiment of the present invention, a method, implemented on a computing device, for brokering the download of an original image, the method including receiving a download request with a requested UPID where the UPID is a mathematical construct with a generally unique, resolution independent, relationship with a particular image; matching the requested UPID to a stored UPID; and forwarding the download request to a storage device, where the storage device is associated with the matched stored UPID.

Further, in accordance with a preferred embodiment of the present invention, the matching includes looking up a shortened version of the requested UPID from a list of stored shortened versions of the stored UPIDs; and matching the requested UPID to the stored UPID, where the stored UPID is associated with the looked up shortened version of the stored UPID.

Still further, in accordance with a preferred embodiment of the present invention, the matching also includes, upon an unsuccessful result from the matching, storing the requested UPID in a queue; and periodically repeating the matching for the stored requested UPID until at least one matching is successful and a configurable time threshold is reached.

Additionally, in accordance with a preferred embodiment of the present invention, the method also includes relaying communications between the storage device and a requesting device, where the requesting device is associated with the download request.

Additionally, in accordance with a preferred embodiment of the present invention, the method also includes receiving the original image from the storage device, where the original image is associated with the stored UPID; and forwarding the received original image to a requesting device, where the requesting device is associated with the download request.

There is also provided, in accordance with a preferred embodiment of the present invention, a method, implemented on a computing device, for providing original images, the method including uploading at least an indication of an original image to an image tracking server; receiving a download request from the server requesting a copy of the original image, where the original image is requested based on matching a calculated UPID to a requested UPID associated with an image accessed via a requesting device, where the UPID is a mathematical construct with a generally unique, resolution independent, relationship with the original image; and providing the original image to the requesting device.

Further, in accordance with a preferred embodiment of the present invention, the providing includes communicating with the requesting device via a peer to peer connection.

Still further, in accordance with a preferred embodiment of the present invention, the providing includes communicating with the requesting device via at least one of the server, SMS, email and MMS.

Additionally, in accordance with a preferred embodiment of the present invention, the indication is at least the calculated UPID.

Moreover, in accordance with a preferred embodiment of the present invention, the method also includes calculating the calculated UPID.

Further, in accordance with a preferred embodiment of the present invention, the indication is at least one of a shortened version of the calculated UPID and a thumbnail image.

Still further, in accordance with a preferred embodiment of the present invention, the method also includes at least one of calculating the shortened version of the calculated UPID; and generating the thumbnail image.

There is also provided, in accordance with a preferred embodiment of the present invention, a method, implemented on a computing device, for providing original images, the method including transmitting at least indications of original images to be stored on an image brokerage server, where the original images are stored on a separate storage device and available for transmission to users of the server; indicating a target user to offer a copy of the original image; and providing the original image to the target user.

Further, in accordance with a preferred embodiment of the present invention, the indications are at least one of a UPID for the original image, where the UPID is a mathematical construct with a generally unique, resolution independent, relationship with the original image; a thumbnail image; and a reduced version of the original image.

Still further, in accordance with a preferred embodiment of the present invention, the method also includes providing addressing details for the target user if the target user is not a previously registered user of the server.

There is also provided, in accordance with a preferred embodiment of the present invention, a method, implemented on a computing device, for brokering the transfer of copies of original images, the method including storing at least indications of original images on an image brokerage server, where the original images are stored on a separate storage device and available for transmission to users of the server; receiving a selection of a target user to offer a copy of the original image; forwarding the offer to the target user; receiving an answer from the target user; and forwarding the answer to the separate storage device.

Further, in accordance with a preferred embodiment of the present invention, the method also includes sending the indications to the target user in response to the answer.

Still further, in accordance with a preferred embodiment of the present invention, the method also includes registering the target user as a user of the image brokerage server.

Additionally, in accordance with a preferred embodiment of the present invention, the indications are at least one of a UPID for the original image, where the UPID is a mathematical construct with a generally unique, resolution independent, relationship with the original image; a thumbnail image; and a reduced version of the original image.

There is also provided, in accordance with a preferred embodiment of the present invention, an image downloader module including an image downloader to download a copy of an image; a UPID calculator to calculate a UPID for the downloaded copy, where the UPID is a mathematical construct with a generally unique, resolution independent, relationship with an original version of the copy; and a broker communication module to forward a request for the original version to an image brokerage server, where the server stores at least a list of the UPIDs and an address for an associated the original version.

Further, in accordance with a preferred embodiment of the present invention, the module also includes an image scanning unit to scan available images for the image downloader to download.

Still further, in accordance with a preferred embodiment of the present invention, the image scanning unit is configurable to search for images with specific criteria.

Additionally, in accordance with a preferred embodiment of the present invention, the criteria include at least one of tags and faces.

Moreover, in accordance with a preferred embodiment of the present invention, the module also includes means to receive the original version from the stored address on the server.

Further, in accordance with a preferred embodiment of the present invention, the means comprise at least one of peer-to-peer connectivity, email, SMS, MMS and transmission via the server.

There is also provided, in accordance with a preferred embodiment of the present invention, an image indexing and brokerage server including a UPID receiver to receive UPIDs, where the UPID is a mathematical construct with a generally unique, resolution independent, relationship with an original version of an image; a UPID index to store the UPIDs received via the UPID receiver, where the UPID is associated with the original version of an image on an image storage device; a UPID lookup module to lookup the requested the UPIDs received via the UPID receiver from a requesting user as part of a download request; and a download broker to at least contact the image storage device to forward the download request, where the requested UPID matches the UPID stored in the UPID index and associated with the image storage device.

Further, in accordance with a preferred embodiment of the present invention, the image indexing and brokerage server also includes a keep looking queue with the requested UPIDs that are not found in the UPID index by the UPID lookup module, where the UPID lookup module is configurable to periodically lookup the requested UPIDs from the queue in the UPID index.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of novel full-sized digital image dissemination system, constructed and operative in accordance with a preferred embodiment of the present invention;

FIGS. 2-4 are block diagrams of processes associated with the system of FIG. 1;

FIG. 5 is a schematic illustration of a novel “pushed” image distribution system, constructed and operative in accordance with a preferred embodiment of the present invention; and

FIG. 6 is a schematic illustration of an alternative novel “pushed” image distribution system, constructed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

As discussed hereinabove in the Background, it may be impractical to post original full resolution images on social networks. However, even though full sized images may not be stored on the social networks themselves, such full sized images may still be stored on the computing devices used by the posting members. Applicant has realized that if the posted versions on the social networks may somehow be associated with the original versions stored by the posting members, it may be possible to obtain a full sized version of a reduced resolution image posted on a social network.

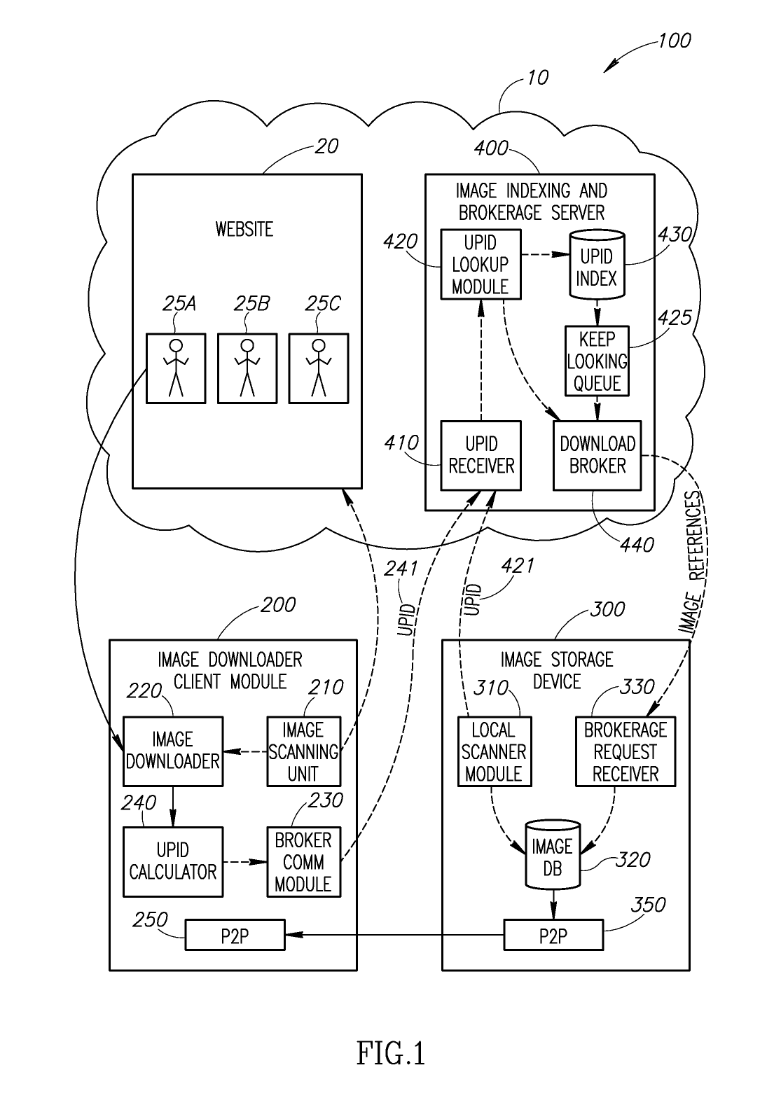

Reference is now made to FIG. 1 which illustrates a novel full-sized digital image dissemination system 100, constructed and operative in accordance with a preferred embodiment of the present invention. System 100 may comprise an image downloader client module 200, an image storage device 300, and an image indexing and brokerage server 400. It will be appreciated that the depiction of image downloader client module 200 and image storage device 300 may be exemplary; in accordance with an alternative preferred embodiment of the present invention, the functionality of client 200 and device 300 may be combined in a single entity. Server 400 may be located in Internet 10 and may be configured to communicate with module 200 and device 300. Website 20 may also be accessible via Internet 10 and in accordance with a preferred embodiment of the present invention it may represent a social network site, such as, for example, Facebook. It will be appreciated, however, that as will be disclosed hereinbelow, website 20 may represent any suitable website that may contain downloadable digital images such as reduced size images 25.

Module 200 may be installed on any suitable computing device, such as for example a personal computer. It may comprise image scanning unit 210, image downloader 220, broker communication module 230, UPID calculator 240 and P2P functionality 250. Device 300 may be a suitable computing device and comprise database 320 that may contain full sized versions of reduced sized images 25 such as those on website 20. In accordance with a preferred alternative embodiment of the present invention, Module 200 and device 300 may also be implemented as thin clients accessing web-based functionality via the Internet. As will be described hereinbelow, system 100 may be configured such that server 400 may associate reduced size images 25 with full sized versions in database 320 to facilitate the receipt of full sized versions of images 25 directly from device 300.

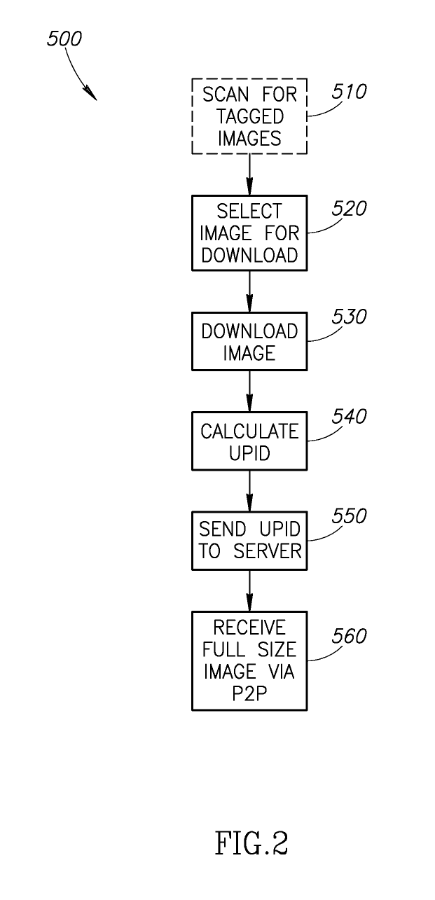

Reference is now made to FIG. 2 which illustrates a novel full image download process 500 which may be performed by module 200 to download full sized versions of reduced size images 25. Image scanning unit 210 may scan (step 510) website 20 for images that have been tagged with a name associated with a user registered with module 200. It will be appreciated that such registration may be performed as part of a setup procedure when module 200 may be installed or at a later date. It will also be appreciated that image scanning unit 210 may be configured to perform step 510 periodically, proactively by user initiation, or both. It will be further appreciated that image scanning unit 210 may be implemented as an automated server accessed via the Internet.

Image downloader 220 may present (step 520) the tagged images found in step 510 for selection by the user, who may use any suitable method for selection to perform the selection. Downloader 220 may download (step 530) a copy of each of the selected images from website 20. In accordance with an alternative embodiment of the present invention, process 500 may also be implemented to begin with step 520 without first performing step 510. For example, the user may proactively initiate process 500 while browsing website 20 by “right clicking” and selecting a “download full sized image” option from a menu.

UPID calculator 240 may calculate a “unique picture ID” (UPID) 241 for each downloaded image. UPID 241 may be calculated using known algorithms to generate a “fingerprint” code by hashing the bits of the image's file. A large UPID, for example one of 8 KB may be generated to correlate with its image file to a high degree of certainty.

Broker communication module 230 may send UPID 241 to server 400 which may, as will described hereinbelow, facilitate the receipt of a full sized version of an image corresponding to UPID 241 directly from device 300. Process 500 may end with P2P (peer-to-peer) unit 250 receiving (step 560) the full sized image from device 300. It will be appreciated that other means for receiving the full sized image may be used instead of, or in combination with, P2P unit 250. For example, the full sized image may also be received via email, MMS, and/or store and forward methods using an intermediary server, such as, but not limited to, server 400.

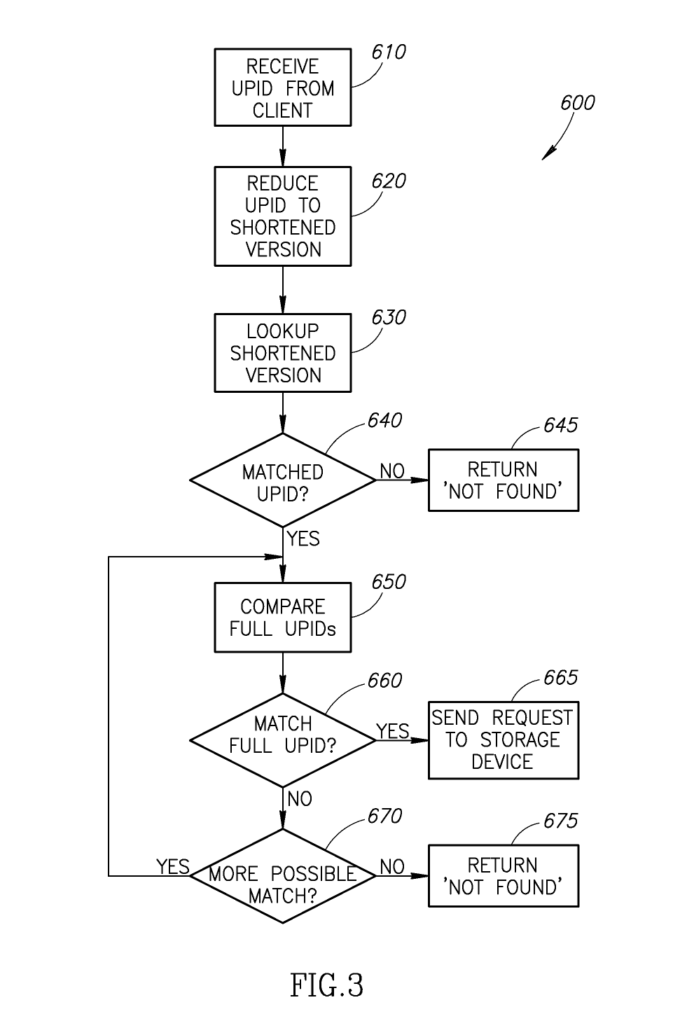

Reference is now made to FIG. 3 which illustrates a novel lookup and brokerage process 600 to be performed by server when receiving UPID 241 from client module 200. Server 400 may comprise UPID receiver 410, UPID lookup module 420, UPID index 430 and download broker 440. UPID receiver 410 may be configured to receive (step 610) UPID 241s sent by client modules 200. UPID lookup module 420 may reduce (step 620) UPID 421 to a shortened version 241′ by any known statistical method, such as, for example, hashing. In accordance with a preferred embodiment of the present invention, module 200 may send an eight kilobyte UPID 241 and step 620 may reduce it to a shortened version 241′ of only 64 bytes. In accordance with an alternative preferred embodiment of the present invention, module 200 may also be configured with the functionality required to derive shortened version 241′ and may send it to server 400 along with UPID 241.

UPID lookup module may lookup (step 630) shortened UPID 241′ in UPID index 430. It will be appreciated that details regarding full sized images on devices 300 may be registered on a continuing basis in UPID index 430. Such details may include a shortened UPID 421′ (not shown), a full UPID 421 and a location indicator for each image registered with server 400. If a match for UPID 241 is not found (step 640), process 600 may return a result (step 645) of “not found”.

It will be appreciated that shortened UPID 241′ may not be sufficient to reliably identify a registered image as being associated with a full sized UPID 241 as received from client module 200. UPID 241′ there may be multiple instances of identical UPID 421′s for a single given UPID 241′, each one presumably associated with a different UPID 421. According to empirical studies, a match for a 64 byte shortened UPID 241′ may be accurate approximately 98% of the time. Accordingly, once a UPID 421′ match has been found for shortened version 241′, lookup module 420 may also compare (step 650) the original UPID 241 received from module 200 with the associated UPID 421 to increase the reliability of the match.

If UPID 241 matches (step 660) the associated UPID 421, then download broker 440 may send (step 665) a download request to device 300. Such a request may include, for example, UPID 421, an associated serial number that may be used to identify and access the image on device 300 and an accessible address for the device of module 200. It will be appreciated that each image record in index 430 may also comprise an accessible address for device 300. It will be appreciated that device 300 may not be available at the time that download broker 440 sends the download request. In such a case, step 665 may return a result of “offline”. For example, if device 300 is a personal computer, it may be turned off or just not connected to the Internet at the time. If device 300 is offline, the request may be saved and resent later per a configurable procedure for “pinging” offline devices.

If UPID 241 does not match (step 660) the associated UPID 421, then lookup module 420 may check (step 670) for more possible matches, i.e. whether or not there are more matched UPID 421′s in UPID index 430. If there are more matches, then control may return to step 650. Otherwise process 600 may return (step 675) a result of not found. It will be appreciated that in the event of a “not found” result (step 645 or 675), server 400 may also send a “not found” message to broker communication module 230. Accordingly, process 600 may end either by sending a request to image storage device 300 or by returning a “not found” message to client module 200.

In accordance with another preferred embodiment of the present invention, server 400 may also comprise a “keep looking” queue 425. In this embodiment, “not found” messages may not always be sent to module 200. Instead, or in addition to, server 400 may add the relevant UPID 241 and its associated details to queue 425. Lookup module 420 may then periodically lookup shortened versions 241′ from queue 425 on the assumption that the relevant UPID 241 may have been uploaded to server 400 after the initial lookup. If found, processing may continue as in the previous embodiments. It will be appreciated that the determination of which UPIDs may be added to queue 425 may be configurable on module 200 and/or server 400. Similarly, module 200 and/or queue 425 may be configurable to indicate how long queued entries may be stored before deletion. Similarly, in the event that device 300 may return a “not found” message from device 300 via download broker 440, server 400 may add the relevant UPID 241 and its associated details to queue 425 as in the previous embodiment.

Image storage device 300 may comprise local scanning module 310, image tracking database 320, brokerage request receiver 330 and P2P unit 350. Local scanning module 310 may be configured to scan device 300 for images. In accordance with a preferred embodiment of the present invention, scanning module 310 may identify all files on device 300 with suffixes indicative of image files, for example, .jpg, .jpeg, .bmp, .tif, .gif, etc. Scanning module 310 may also comprise functionality for calculating UPIDs, similar to UPID calculator 240. Scanning module 310 may calculate a UPID for each found image and store the calculated UPID as well as the associated file system address in image tracking database 320. Each UPID record in image tracking database 320 may also be assigned a serial number that may be used to access the associated record. It will be appreciated that image database 320 may therefore store information about the found images, but not necessarily the images themselves. The images scanned by module 310 may be located anywhere on device 300 and may or may not be organized in a specific database. Local scanning module 310 may perform such scanning on a periodic basis or by any automatic watching mechanism such as is known in the art to be updated as per the images found and/or removed since the previous update to server 400. These updates may include full sized UPIDs 421 that may then be uploaded to server 400 to be stored in UPID index 430, however, the actual images themselves are not uploaded to server 400. Accordingly, for each image registered in image tracking database 320, a corresponding UPID 421, shortened UPID 421′ and the associated serial number may be uploaded to server 400 and stored in UPID index 430. It will be appreciated that module 310 may also be configured to scan on demand as per user request.

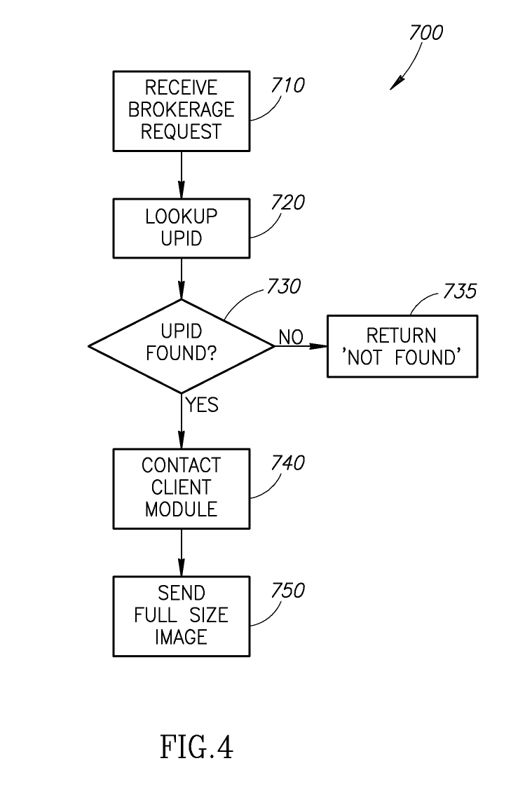

Reference is now made to FIG. 4 which illustrates a novel process 700 to be performed on device 300 when receiving a request from server 400. Brokerage request receiver 330 may receive (step 710) requests for full sized images from download broker 440. Such requests may, as disclosed hereinabove, include at least UPID 421 and an address for communicating with client module 200.

Brokerage request receiver 330 may lookup (step 720) the received UPID 421 in image database 320. If not found (step 730), Brokerage request receiver 330 may return a “not found” message to download broker 440. Otherwise, if found (step 730), P2P unit 350 may contact (step 740) client module 200 via P2P unit 250 and send (step 750) the full sized image as requested. In accordance with a preferred embodiment of the present invention, a rules based configuration system may be implemented on device 300 to enable a user to define criteria for who may receive the images stored on device 300 and under what circumstances. For example, some images may be defined as free for everyone. Images may be restricted for to specific contacts and/or groups of contacts. Some images may be watermarked prior to transfer. Some potential recipients may even be blacklisted.

It will be appreciated that the present invention may include means other than peer to peer connectivity for transferring the full sized image between device 300 and client module 200. Any suitable technology and/or architecture may also be used. For example, the image may alternatively be transferred via server 400. Furthermore, it will also be appreciated that the owner of device 300 may require a fee for the transfer. For example, in some embodiments of the present invention device 300 may represent a download for pay website. In accordance with a preferred embodiment of the present invention, server 400 may be configured to broker such payment vis-a-vis client module 200 on behalf of the owner of device 300. Alternatively, the payment may be handled by other means including, for example, a peer to peer connection between client module 200 and device 300.

It will also be appreciated that there may be disputes regarding ownership of the full sized files. Multiple instances of the same image file may be recorded in UPID index 430. Server 400 may therefore be configured with a dispute manager module (not shown) that may arbitrate between conflicting claims of ownership that may be inferred from such multiple instances. The dispute manager module may be configured with standard arbitration rules to determine ownership. For example, the larger the original file, the more likely that it is the original and implies ownership. Similarly, greater resolution may tend to indicate prior ownership. Where applicable, a more complete meta tag may also indicate a greater likelihood of ownership. It will be appreciated that UPID index 430 may be configured to store such details on a UPID basis in order to assess ownership when a conflict may arise. The dispute manager module may also be configured with user interfaces to facilitate manual intervention and dispute reconciliation.

It will be appreciated that the present invention may also include embodiments relating to digital images that are disseminated via other vehicles in addition to, or instead of, social networks. For example, digital images are also typically found on news/commercial websites and blogs. These digital images may also often be available for forwarding/downloading by visitors of the relevant website/blog. Accordingly, process 500 may also be used to initiate a download of full sized versions of such digital images.

Email is also a popular vehicle for the dissemination of digital images. As many email services limit the size of file attachments, it is not unusual for users to use reduced versions of digital images when using email. It will therefore be similarly appreciated that the present invention may also include an embodiment for requesting a download of the full sized version of a digital image received in an email attachment.

It will be appreciated that the embodiments of FIG. 1 provide a system and methods for “pulling” images from devices 300, wherein users of modules 200 may initiate requests to receive full sized images from devices 300. Applicant has realized that the infrastructure for system 100 may also be leveraged to provide a system for “pushing” images from devices 300 to users of modules 200, wherein a user with images on a device 300 may proactively offer them to a target user of a module 200.

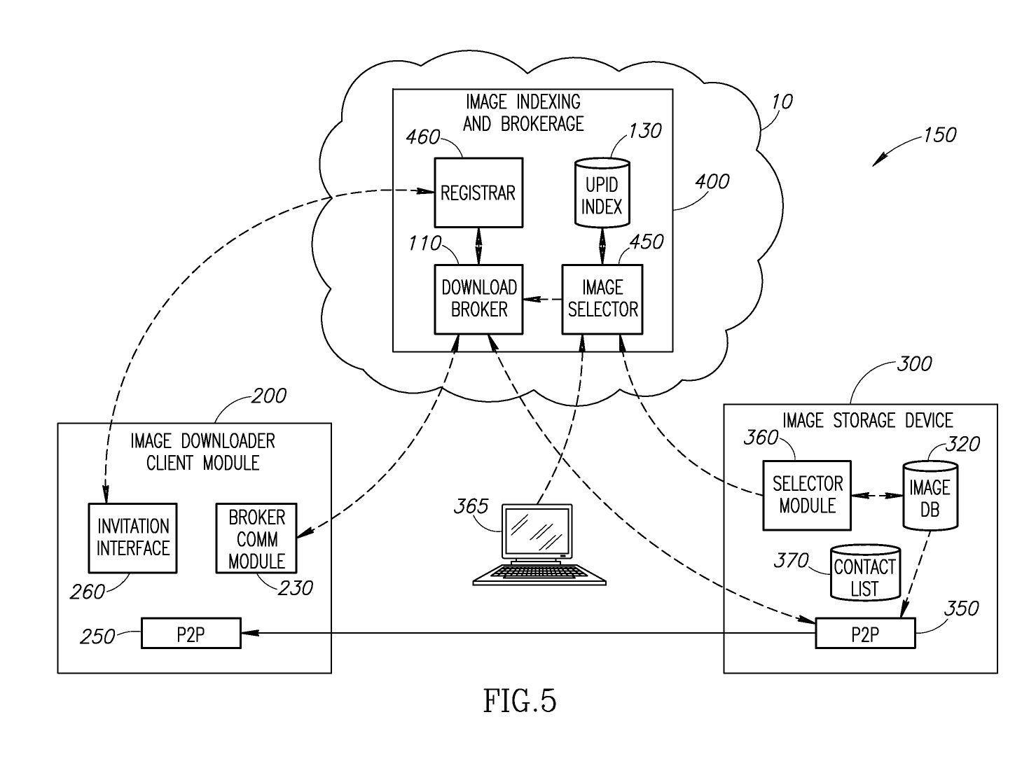

Reference is now made to FIG. 5 which illustrates a novel “pushed” image distribution system 150, constructed and operative in accordance with a preferred embodiment of the present invention. Similar to system 100, system 150 may comprise image index and brokerage server 400, at least one image downloader client module 200 and at least one image storage device 300. It will be appreciated that server 400, module 200 and device 300 may comprise the same elements as depicted in the embodiments of FIG. 1. However, in the interests of clarity only the elements required for the added functionality of system 150 may be illustrated in FIG. 5.

In addition to the previously described functionality, device 300 may also comprise selector module 360 and contact list 370. Selector module 360 may be configured to enable a user of device 300 to browse image tracking database 320 and select images from those tracked in image tracking database 320 to offer to target users and/or potential users of modules 200. Module 360 may also be configured to access contact list 370 to enable a selecting user to select specific target users represented in contacts list 370 to be offered selected images for download. Module 360 may forward the serial numbers of the selected images and the associated contact information for the selected target user(s) to server 400 via the Internet. The associated contact information may be any suitable means for uniquely addressing the selected target user(s), such as, for example, a phone number, email address or a dedicated username for systems 100 and 150.

It will be appreciated that contact list 370 may be any suitable database of contact information. For example, if device 300 may be a mobile communications device, then contact list 370 may be a native contact list application that may be browsed via an API. Alternatively, contact list 370 may be a dedicated list of users of systems 100 and/or 150.

In addition to the previously described functionality, server 400 may comprise image selector 450 and registrar 460. Image selector 450 may be configured to receive the serial numbers and addressing information from selector module 360 and forward them to download broker 440. Registrar 460 may enter and store details regarding registered users of systems 100 and 150.

In accordance with an alternative preferred embodiment of the present invention, UPID index 430 may store a thumbnail and/or reduced version of the images in addition to UPIDs 421 and shortened versions 421′ for each tracked image. Image selector 450 may access UPID index 430 and also forward associated thumbnails and/or reduced version images to download broker 440.

It will be appreciated that it may not be necessary to involve device 300 itself in order to initiate an offer of images to the user of module 200. In accordance with an alternative preferred embodiment of the present invention, the user or owner of the images on device 300 may use any standard Internet enabled computing device, such as, for example, personal computer 365 to access an interactive version of image selector 450 to select images to offer other users. Image selector 450 may display thumbnails and/or reduced versions of the images from UPID index 430 to facilitate the selection. It will be appreciated that the user of device 300 may also access an interactive version of image selector 450 via an Internet browser on device 300 instead of via selector module 360.

As discussed hereinabove, the target user may be identified by unique addressing information such as a phone number, email address or a dedicated username for systems 100 and 150. Download broker 440 may access registrar 460 to check whether or not a target user's addressing information belongs to a registered user of systems 100/150. If the target user is a registered user, registrar may provide download broker with a preferred address for contacting broker comm module 230. Download broker 440 may contact broker comm module 230 on module 200 to present the offer of images from the user of device 300.

In accordance with a preferred embodiment of the present invention, download broker may forward a thumbnail version of the offered images as part of the offer. The target user may use broker comm module 230 to accept the offer and the image(s) may be transmitted to module 200 as in the previous embodiments, using for example, P2P units 250 and 350. It will be appreciated, however, that other transmission vehicles may be employed such as, for example, email or via server 400.

The target user may also request more information from download broker 440. In response, download broker 400 may forward a larger (yet still reduced) version of the image for the target user to consider. The target user may also, choose to reject the offer. As in the previous embodiments, download broker may be configured to relay conditions and/or prices for use of the offered images.

If the target user's addressing information is not found by registrar 460, registrar 460 may send an invitation to an invitation interface 260 associated with the target user as per the addressing information. For example, if the addressing information is an email address, interface 260 may be an email client; if the addressing information is a phone number, interface 260 may be an SMS client. If the target user accepts the invitation, registrar 460 may enter the target user's details and the process may continue as described hereinabove. It will be appreciated that in such manner membership in systems 100/150 may spread virally.

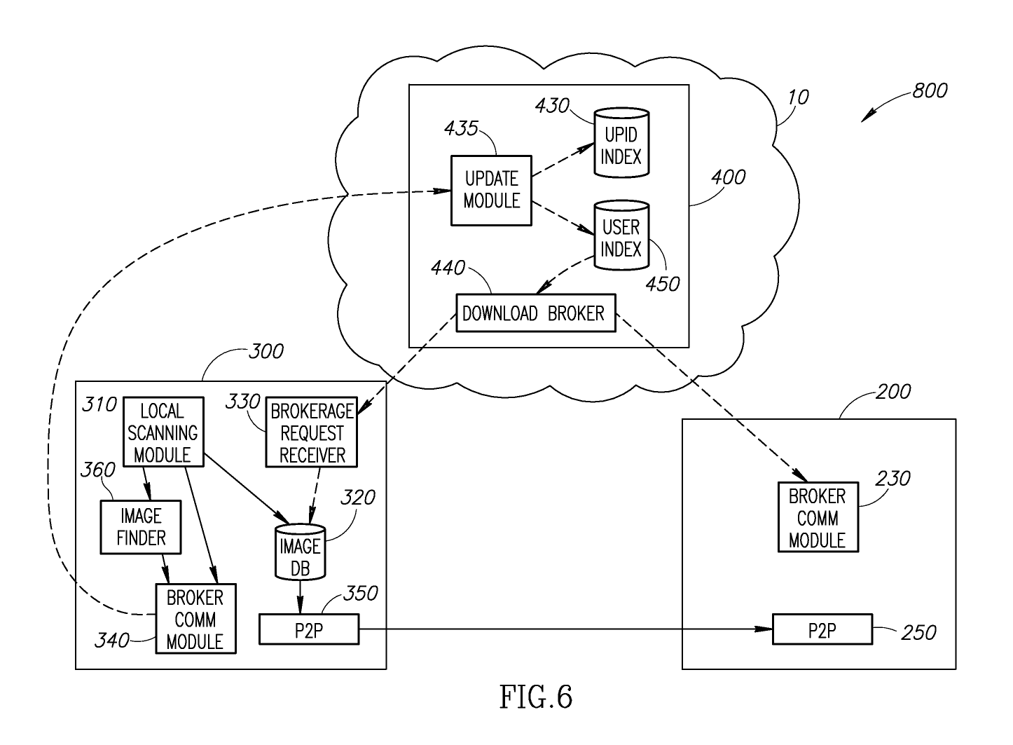

Applicant has realized that users may also be interested in receiving non-tagged images of themselves and/or images of themselves that may have been posted on sites other than social networks of which they are members. Reference is now made to FIG. 6 which illustrates a novel “pushed” image distribution system 800, constructed and operative in accordance with a preferred embodiment of the present invention. Similar to systems 100/150, system 800 may comprise image indexing and brokerage server 400, image downloader client module 200 and image storage device 300; similar reference numerals may refer to similar elements.

Image storage device 300 may comprise generally the same elements as in the embodiment of system 100. However, in accordance with an alternative preferred embodiment of the present invention, image storage device 300 may also comprise image finder 360 and broker comm module 340. Image finder 360 may be an application or interface that may be configured to identify the people depicted in the images found by local scanning module 310. Any suitable application or interface may provide such functionality, for example, an interface with a face recognition site such as face.com. Image finder 360 may process the images in an attempt to identify a person or persons in the images received from local scanning module 310.

If a person is identified by image finder 360, it may forward identifying details such as a known Facebook account name or associated email to server 400 via broker comm module 340. It will be appreciated that broker comm module 340 may also forward UPIDs, shortened UPIDs, thumbnails and/or reduced image versions to server 400 as in previous embodiments.

Image indexing and brokerage server 400 may comprise generally the same elements as in the embodiment of system 100. However, in accordance with an alternative preferred embodiment of the present invention, server 400 may also comprise update module 425 and user index 250. User index 250 may store registration details of users registered via registrar 460 as disclosed in the context of previous embodiments. Update module 435 may receive the identifying details from broker comm module 340 as well as UPIDs, shortened UPIDs, thumbnails and/or reduced image versions. Update module 435 may update UPID index 430 as per the requirements of the previous embodiments; i.e. it may add and/or update entries for each image with the received UPIDs, shortened, UPIDs, thumbnails and/or reduced image versions.

Update module may also use the identifying details to lookup the identified person in user index 450. If the identifying details match those of a registered user of system 800, download broker 440 may contact a module 200 associated with the matched user to offer the user to download a copy of the image in which the person was identified.

Broker comm module 230 may receive the offer from download broker 440. The logic for negotiating/accepting the offer and receiving the download may then be performed according to the previous embodiments.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer/mobile phone/tablet etc . . . Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method, implementable on a computing device, for downloading original images comprising:
downloading an image via a communications network;
calculating a unique picture ID (UPID) for said downloaded image, wherein said UPID is a mathematical construct with a generally unique, resolution independent, relationship with said downloaded image;
sending a download request with at least said calculated UPID to an image brokerage server, wherein said brokerage server is configured to store at least said UPIDs associated with said original resolution images stored on other devices; and
receiving said original resolution image of said downloaded image from one of said other devices, wherein said UPID associated with said original resolution image matches said calculated UPID.

2. The method according to claim 1 and also comprising:
scanning websites for tagged images to download.

3. The method according to claim land also comprising:
enabling a user to select said image for said downloading.

4. A method, implemented on a computing device, for brokering the download of an original image, the method comprising:
receiving a download request with a requested UPID wherein said UPID is a mathematical construct with a generally unique, resolution independent, relationship with a particular image;
matching said requested UPID to a stored UPID; and
forwarding said download request to a storage device, wherein said storage device is associated with said matched stored UPID.

5. The method according to claim 4 and wherein said matching comprises:
looking up a shortened version of said requested UPID from a list of stored shortened versions of said stored UPIDs; and
matching said requested UPID to said stored UPID, wherein said stored UPID is associated with said looked up shortened version of stored UPID.

6. The method according to claim 4 and wherein said matching also comprises:
upon an unsuccessful result from said matching, storing said requested UPID in a queue; and
periodically repeating said matching for said stored requested UPID until at least one: said matching is successful and a configurable time threshold is reached.

7. The method according to claim 4 and also comprising:
relaying communications between said storage device and a requesting device, wherein said requesting device is associated with said download request.

8. The method according to claim 4 and also comprising:
receiving said original image from said storage device, wherein said original image is associated with said stored UPID; and
forwarding said received original image to a requesting device, wherein said requesting device is associated with said download request.

9. A method, implemented on a computing device, for providing original images, the method comprising:
uploading at least an indication of an original image to an image tracking server;
receiving a download request from said server requesting a copy of said original image, wherein said original image is requested based on matching a calculated UPID to a requested UPID associated with an image accessed via a requesting device, wherein said UPID is a mathematical construct with a generally unique, resolution independent, relationship with said original image; and
providing said original image to said requesting device.

10. The method according to claim 9 and wherein said providing comprises:
communicating with said requesting device via a peer to peer connection.

11. The method according to claim 9 and wherein said providing comprises:
communicating with said requesting device via at least one of said server, SMS, email and MMS.

12. The method according to claim 9 and wherein said indication is at least said calculated UPID.

13. The method according to claim 9 and also comprising:
calculating said calculated UPID.

14. The method according to claim 9 and wherein said indication is at least one of a shortened version of said calculated UPID and a thumbnail image.

15. The method according to claim 9 and also comprising at least one of:
calculating said shortened version of said calculated UPID; and
generating said thumbnail image.

16. A method, implemented on a computing device, for providing original images, the method comprising:
transmitting at least indications of original images to be stored on an image brokerage server, wherein said original images are stored on a separate storage device and available for transmission to users of said server;
indicating a target user to offer a copy of said original image; and
providing said original image to said target user.

17. The method according to claim 16 and wherein said indications are at least one of:
a UPID for said original image, wherein said UPID is a mathematical construct with a generally unique, resolution independent, relationship with said original image;
a thumbnail image; and a
a reduced version of said original image.

18. The method according to claim 16 and also comprising:
providing addressing details for said target user if said target user is not a previously registered user of said server.

19. A method, implemented on a computing device, for brokering the transfer of copies of original images, the method comprising:
storing at least indications of original images on an image brokerage server, wherein said original images are stored on a separate storage device and available for transmission to users of said server;
receiving a selection of a target user to offer a copy of said original image;
forwarding said offer to said target user;
receiving an answer from said target user; and
forwarding said answer to said separate storage device.

20. The method according to claim 19 and also comprising:
sending said indications to said target user in response to said answer.

21. The method according to claim 19 and also comprising:
registering said target user as a user of said image brokerage server.

22. The method according to claim 19 and wherein said indications are at least one of:
a UPID for said original image, wherein said UPID is a mathematical construct with a generally unique, resolution independent, relationship with said original image;
a thumbnail image; and a
a reduced version of said original image.

23. An image downloader module comprising:
an image downloader to download a copy of an image;
a UPID calculator to calculate a UPID for said downloaded copy, wherein said UPID is a mathematical construct with a generally unique, resolution independent, relationship with an original version of said copy; and
a broker communication module to forward a request for said original version to an image brokerage server, wherein said server stores at least a list of said UPIDs and an address for an associated said original version.

24. The module according to claim 23 and also comprising an image scanning unit to scan available images for said image downloader to download.

25. The module according to claim 23 and wherein said image scanning unit is configurable to search for images with specific criteria.

26. The module according to claim 25 and wherein said criteria include at least one of tags and faces.

27. The module according to claim 23 and also comprising means to receive said original version from said stored address on said server.

28. The module according to claim 27 and wherein said means comprise at least one of peer-to-peer connectivity, email, SMS, MMS and transmission via said server.

28. An image indexing and brokerage server comprising:
a UPID receiver to receive UPIDs, wherein said UPID is a mathematical construct with a generally unique, resolution independent, relationship with an original version of an image;
a UPID index to store said UPIDs received via said UPID receiver, wherein said UPID is associated with said original version of an image on an image storage device;
a UPID lookup module to lookup said requested said UPIDs received via said UPID receiver from a requesting user as part of a download request; and
a download broker to at least contact said image storage device to forward said download request, wherein said requested UPID matches said UPID stored in said UPID index and associated with said image storage device.

29. The image indexing and brokerage server according to claim 28 and also comprising:
a keep looking queue with said requested UPIDs that are not found in said UPID index by said UPID lookup module, wherein said UPID lookup module is configurable to periodically lookup said requested UPIDs from said queue in said UPID index.
